(19) United States
(12) Patent Application Publication
(10) Pub. No.: US 2020/0189046 A1
(43) Pub. Date: Jun. 18, 2020

(54) LOCOMOTIVE HEAT EXCHANGER APPARATUS AND METHOD OF MANUFACTURING A HEAT EXCHANGER APPARATUS

(71) Applicant: GENERAL ELECTRIC COMPANY, Schenectady, NY (US)

(72) Inventors: BALAJI HOSADURGAM RAVINDRANATH, BANGALORE (IN); HARISH GANAPATHY, BAGALORE (IN)

(73) Assignee: GENERAL ELECTRIC COMPANY, SCHENECTADY, NY (US)

(21) Appl. No.: 16/217,451

(22) Filed: Dec. 12, 2018

(51) Int. Cl. B23P 15/26; F28F 1/26; F28D 1/053; F28F 13/08

(52) U.S. Cl. CPC B23P 15/26; F28F 1/26; B21D 53/085; F28D 1/05375; F28F 13/08; F28D 1/05391

(57) ABSTRACT

A locomotive heat exchanger apparatus includes a header having at least one opening, at least one tubular member joined to the header and having an interior passageway in fluid communication with the at least one opening, and a plurality of radial fins extending from the at least one tubular member. The tubular member and the plurality of radial fins may be formed as a unitary component via additive manufacturing without welding or interference fit.

### BACKGROUND

### Technical Field

Embodiments of the invention relate generally to heat exchangers and, more particularly, to tube-and-fin style heat exchangers and methods for manufacturing tube-and-fin style heat exchangers.

### DISCUSSION OF ART

Large, heavy-duty machines such as locomotives, tractors, loaders, excavators, and other off-highway vehicles typically employ various heat exchanger devices for a variety of purposes such as engine cooling, charge air cooling, and exhaust gas cooling. For example, off-highway vehicles may employ a large radiator for engine cooling, an intercooler and/or aftercooler for cooling intake air in between compression stages prior to such air being supplied to the engine, an exhaust gas recirculation (EGR) cooler for cooling exhaust gases that are recirculated to the engine to decrease cylinder temperatures and comply with emissions requirements, and/or an engine oil cooler for cooling working fluids such as engine oil and/or transmission fluid.

One type of heat exchanger that is utilized in radiators, intercoolers, aftercoolers and EGR coolers, alike, is the tube-and-fin style, or finned tube, heat exchanger. Tube-and-fin heat exchangers have tubes with outer fins, for an extended outer surface area that enhances the heat transfer rate. The tubes are connected to headers on their opposing ends, and a first fluid, usually a liquid, is circulated through the tubes. A second fluid, usually a gas, flows outside of the tubes, and heat from the second fluid is absorbed through the fins and carried away by the first fluid, or vice versa when cooling of the first fluid is desired.

The design and construction of tube-and-fin heat exchangers present a number of challenges from a heat transfer perspective. In particular, in order to provide for optimal heat transfer from the second fluid to the first fluid (or vice versa), the fins and walls of the tubes are designed to be very thin. These thin tubes are typically joined by welds to comparatively thick-walled headers, which provide necessary structural rigidity to the heat exchanger. Due to the differences in material thickness between the header, whose purpose is primarily structural, and the tubes, whose functional purpose is primarily heat transfer, when exposed to high temperatures over thousands of cycles, stress cracks can develop at this tube/header interface. These cracks can lead to both a degradation in the heat transfer performance of the heat exchanger, as well as leaking, requiring service and/or replacement.

The joining of the fins to the tubes presents additional design challenges. With existing tube-and-fin heat exchangers, the fins and tubes are typically joined to one another through an interference fit. This type of contact can create a type of thermal contact resistance that can potentially cause a loss in heat transfer between the fins and the tubes. In particular, when the fins and tube are fit together, only a small fraction of the nominal surface area is actually in contact because of the non-flatness and roughness of the contacting surfaces. If a heat flux is imposed across the junction, the uniform flow of heat is generally restricted to conduction through the contact spots. The limited number and size of the contact spots results in an actual contact area which is significantly smaller than the apparent contact area. This limited contact area causes a thermal contact resistance, which can limit the performance of the heat exchanger. Existing solutions to this problem include welding fins around the tube (such as in a spiral configuration), however, the use of welds can lead to similar issues as discussed above, where stress cracks can develop at the fin and tube interface, leading to a degradation in performance which may ultimately require replacement of the heat exchanger.

In view of the above, there is a need for a heat exchanger apparatus that minimizes the potential for stress cracks at the interfaces between components, particularly components of differing material thickness or composition, and substantially eliminates thermal contact resistance at the fin and tube interface.

### BRIEF DESCRIPTION

In an embodiment, a heat exchanger includes a header having at least one opening, at least one tubular member joined to the header and having an interior passageway in fluid communication with the at least one opening, and a plurality of radial fins extending from the at least one tubular member. The tubular member and the plurality of radial fins are formed as a unitary component via additive manufacturing without welding or interference fit.

In another embodiment, a method of manufacturing a heat exchanger includes forming a tubular member having an end preparation configured to facilitate joining of the at least one tubular member to a header plate having an opening. The end preparation is one of a series of slots, a plurality of radial projections, or a plurality of threads. The method further includes joining the tubular member to the header plate. The end preparation is formed via additive manufacturing.

In another embodiment, a method of manufacturing a heat exchanger apparatus includes the step of, via additive manufacturing, integrally forming a tubular member with at least one of a header plate and/or at least one radial fin.

### DRAWINGS

The present invention will be better understood from reading the following description of non-limiting embodiments, with reference to the attached drawings, wherein below:

FIG. 1A is a cross-sectional side view of a tube/header assembly of a tube-and-fin heat exchanger, according to an embodiment of the invention.

FIG. 1B is a cross-sectional side view of a tube/header assembly of a tube-and-fin heat exchanger, according to another embodiment of the invention.

FIG. 1C is a cross-sectional side view of a tube/header assembly of a tube-and-fin heat exchanger, according to another embodiment of the invention.

FIG. 1D is a cross-sectional side view of a tube/header assembly of a tube-and-fin heat exchanger, according to another embodiment of the invention.

FIG. 1E is a cross-sectional side view of a tube/header assembly of a tube-and-fin heat exchanger, according to another embodiment of the invention.

FIG. 2 is a cross-sectional side view of a tube/header assembly of a tube-and-fin heat exchanger, according to another embodiment of the invention.

FIG. 3 is a cross-sectional side view of a tube/header assembly of a tube-and-fin heat exchanger, according to another embodiment of the invention.

FIG. 4 is a cross-sectional side view of a tube/header assembly of a tube-and-fin heat exchanger, according to yet another embodiment of the invention.

FIG. 5 is an end view of a tube member of the tube-and-fin heat exchanger of FIG. 1, according to an embodiment of the invention.

FIG. 6 is a side, cross-sectional view of the tube member of FIG. 5.

FIG. 7 is an end view of a tube member of the tube-and-fin heat exchanger of FIG. 1, according to another embodiment of the invention.

FIG. 8 is a side, cross-sectional view of the tube member of FIG. 7.

FIG. 9 is an end view of a tube member of the tube-and-fin heat exchanger of FIG. 1, according to yet another embodiment of the invention.

FIG. 10 is a side, cross-sectional view of the tube member of FIG. 9.

FIG. 11 is a schematic illustration of an assembly process for a heat exchanger having tubes constructed according to the embodiment of FIGS. 9 and 10.

FIG. 12 is another schematic illustration of an assembly process for a heat exchanger having tubes constructed according to the embodiment of FIGS. 9 and 10.

FIG. 13 is a side, cross-sectional illustration of a tube//header assembly of a tube-and-fin heat exchanger, according to yet another embodiment of the invention.

FIG. 14A is a side elevation view of a portion of a finned tube, and FIG. 14B is a top plan view of the finned tube of FIG. 14A, according to an embodiment.

FIG. 15A is a side elevation view of a portion of a finned tube, and FIG. 15B is a top plan view of the finned tube of FIG. 15A, according to an embodiment.

FIG. 16 is a side elevation view of a portion of another embodiment of a finned tube.

FIG. 17 is a side elevation view of a portion of another embodiment of a finned tube.

FIG. 18 is a top plan view, in cross section, of a finned tube with interior heat transfer members.

FIG. 19 is a top plan view, in cross section, of a finned tube with a helical, curved, or spiral interior heat transfer member.

FIG. 20 is a graph showing a material composition gradation, according to an embodiment.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

As used herein, the term “additive manufacturing” or “3D printing” refers to a process of constructing a 3D component by successively forming (i.e., “printing”) two-dimensional (“2D”) layers of the component from a forming material, e.g., a polymer and/or metal, where the successively formed layers are joined one atop another, for example by joining/binding the 2D layers together via an adhesive, melting, sintering, or other suitable method. Additive manufacturing technologies may include, for example, material extrusion, directed energy deposition, material jetting, binder jetting, sheet lamination, vat polymerization, and powder bed fusion. As used herein, “thin-walled” is defined as a wall thickness less than about 1 millimeter (e.g., no more than 1 millimeter thick). As used herein, “thick-walled” is defined as a wall thickness of greater than about 2 millimeters (e.g., at least 2 millimeters thick).

Embodiments of the invention provide a heat exchanger having a plurality of thin-walled tubular members (also referred to herein as tubes) having respective end portions joined to a comparatively thick-walled header. The header includes a plurality of openings extending therethrough and each of the end portions of the tubular members are secured within the corresponding openings. The tubes include a plurality of fins extending outward therefrom that increase the heat transfer area of the tubes. At least a portion of the tube and/or fins is additively manufactured. For example, the fins and tubes may be additively manufactured as an integrated component without the need for joining the fins to the tubes through an interference fit or welds or otherwise. In addition, the end portions of the tubes may be additively manufactured with one or more features that increase the contact area between the tubes and header (the contact area is increased relative to other configurations without such features, such as the tube end portion having a circular shape that fits into a correspondingly-shaped circular aperture of the header). While embodiments of the invention describe the manufacture of discrete components of a tube-and-fin heat exchanger using additive manufacturing processes, it is contemplated that the entire heat exchanger apparatus may be manufactured using additive technologies. In addition, while embodiments of the invention are described in connection with tube-and-fin type heat exchangers, the additive manufacturing techniques described herein are equally applicable to heat exchanger devices more generally.

In embodiments, a method of manufacturing a heat exchanger apparatus includes, via additive manufacturing, integrally forming a tubular member with at least one of a header plate and/or at least one radial fin. This construction may be joined to a larger header pate through any of the joining processes discussed herein. By doing so, the header/tube joint, rather than being formed from two dissimilar components, will instead be a junction of two similar components having similar thickness and joining properties. This is also aimed at providing modularity of the design, whereby a set of tubes and header plates will be additively manufactured and a plurality of these can be joined to a larger header frame.

The terms “tube” and “tubular member” generally refer to an elongate member with an elongate interior passageway that extends along a length of the elongate member. The member and interior passageway may both be cylindrical, or they may have other cross-sectional configurations (the same or different from one another), e.g., an outer periphery of the member, in lateral cross section, may be square, rectangular, or a different polygonal shape, or it may be circular or oval, or otherwise, and a lateral cross-sectional shape of the interior passageway may be square, rectangular, or a different polygonal shape, or it may be circular or oval, or otherwise.

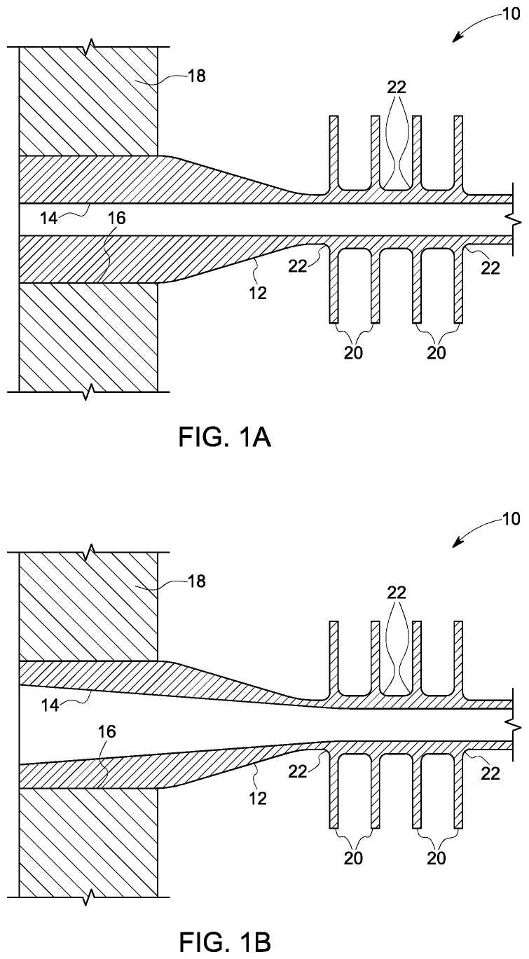

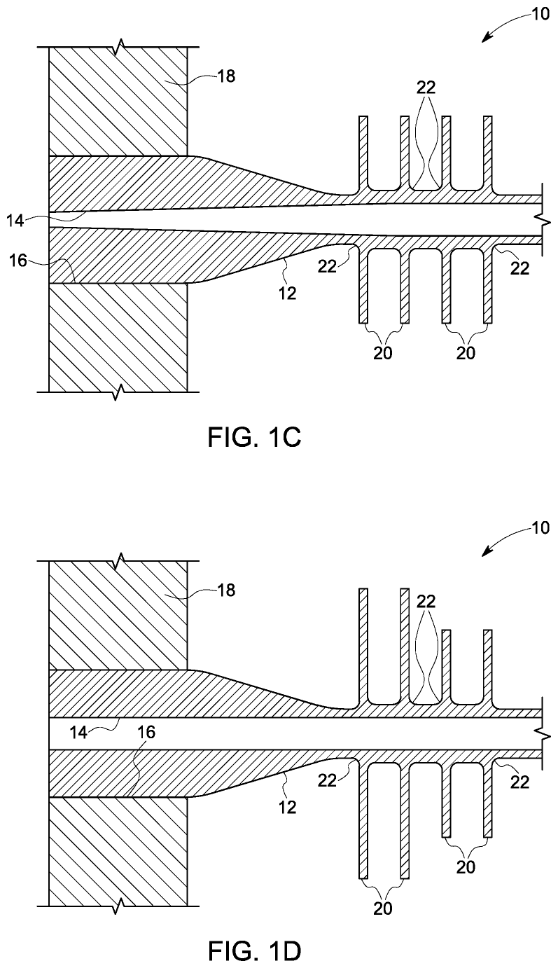

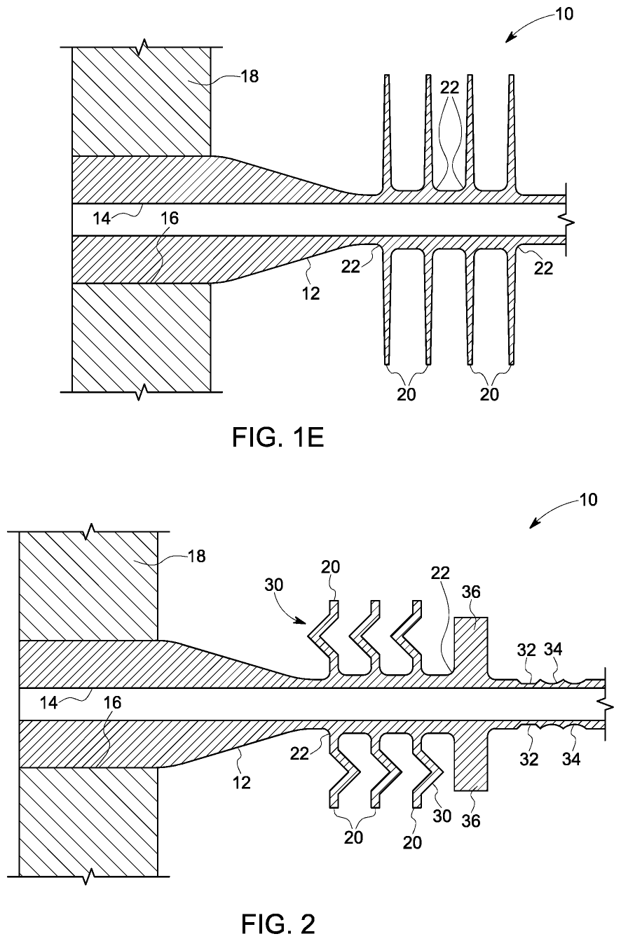

FIG. 1A is a cross-sectional illustration of a portion of a tube-and-fin heat exchanger 10, according to an embodiment of the invention. The heat exchanger 10 includes a series of tubular members or tubes, including tube 12, laid out according to various arrangements such as, for example, staggered, parallel, canted, plate fin, serpentine, CT, and the like. (One tube 12 is shown in FIG. 1A, however, the heat exchanger may include additional such tubes or tubular members, similarly configured.) As shown therein, the tubular members 12 each include an end portion 14 received in an opening 16 in a header 18. As discussed hereinafter, the end portion 14 may be joined to the header 18 such as through welding. In an embodiment, the tubular members may be thin-walled, having a wall thickness less than about 1 millimeter, which helps facilitate heat transfer. Conversely, the header may be generally thick-walled, having a wall thickness of greater than about 2 millimeters. In contrast to the tubular members 12, the header 18 may serve the purpose of providing structural rigidity to the heat exchanger. With further reference to FIG. 1A, the tubular members 12 each include a respective plurality of fins 20 that extend radially therefrom and which function to increase the heat transfer area of the tubular members 12. In an embodiment, the tubular members 12 and fins 20 are formed as an integrated component devoid of any mechanical joints such as, for example, interference fits, welds, or the like. In particular, in an embodiment, the tubular member 12 and fins 20 may be formed as a single, integrated component such as via additive manufacturing (also referred to herein as 3D printing).

By additively manufacturing the tubes and fins in a single operation, the need to separately manufacture the tubes and the fins, and subsequently join them in a separate process step, such as through an interference fit or welding, can be eliminated. Moreover, additively manufacturing the tubes 12 and fins 20 as a single component allows for a full metal contact at the fin-tube interface, thereby substantially minimizing, if not eliminating, the possibility of thermal contact resistance which is present in existing devices comprised of separate tube and fin components. In addition to the above, with further reference to FIG. 1A, by additively manufacturing the tubes 12 and fins 20, fillets 22 can be provided at the tube-fin interface. The ability to provide these fillets 22 at the tube-fin interface reduces the stresses seen in this region when exposed to high temperatures during operation, minimizing the likelihood of crack initiation and propagation. The fillet may be a rounding of an interior corner between the tube and fin, such that there is more integral material in the space of the corner between the two than if the tube and fin corner was defined by a right angle. In addition to a rounded corner, the corner may be angled or beveled, i.e., the corner may be provided with a chamfer. In either case, the tube, fin, and material of the chamfer or fillet between the two may be integrally formed, and thereby one piece, using an additive manufacturing process. (Unless otherwise specified, the term “fillet” as used herein includes chamfers.)

In addition to additively manufacturing the tubes 12 with integral fins 20, fillets 22, etc., the same additive manufacturing techniques may also be utilized to produce tubes 12 having a constant or varying cross-sectional area/wall thickness, and/or a constant or varying inside diameter, as desired. For example, as discussed above, in an embodiment, additive manufacturing can be used to produce tubes 12 having a constant cross-sectional area and inside diameter along the length of the tube (e.g., with a constant wall thickness of about less than 1 millimeter). In other embodiments, additive manufacturing can be utilized to produce tubes 12 where the cross-sectional area and/or wall thickness varies at various longitudinal locations. As shown in FIG. 1A, for example, the tube may be additively manufactured such that the wall thickness of the tube 12 (and thus the cross-sectional area) can be increased at the header end of the tube 12 where it interfaces with the header plate 18, while the inside diameter of the tube 12 remains constant throughout its length. This configuration can be utilized to provide additional strength to the tube/header joint.

The fins 20 may be annular in lateral cross section (in a plane normal to the plane of the view of FIG. 1A). Alternatively, the fins may have lateral cross sections with different outer peripheral shapes, such as square, hexagonal, or some other polygonal shape. Additionally, the fins may not be continuous along the entire circumferential periphery of the tubes, e.g., there may be one fin on one side of the tube and another fin on the opposite side of the tube, or plural fins spaced apart along the circumferential periphery of a tube (e.g., a first fin on one side of the tube, a second fin circumferentially spaced apart from the first fin by a certain number of degrees, a third fin circumferentially spaced apart from the second fin by the same amount, and so on). Such discontinuous fins may be rectangular in lateral cross-sectional shape, for example.

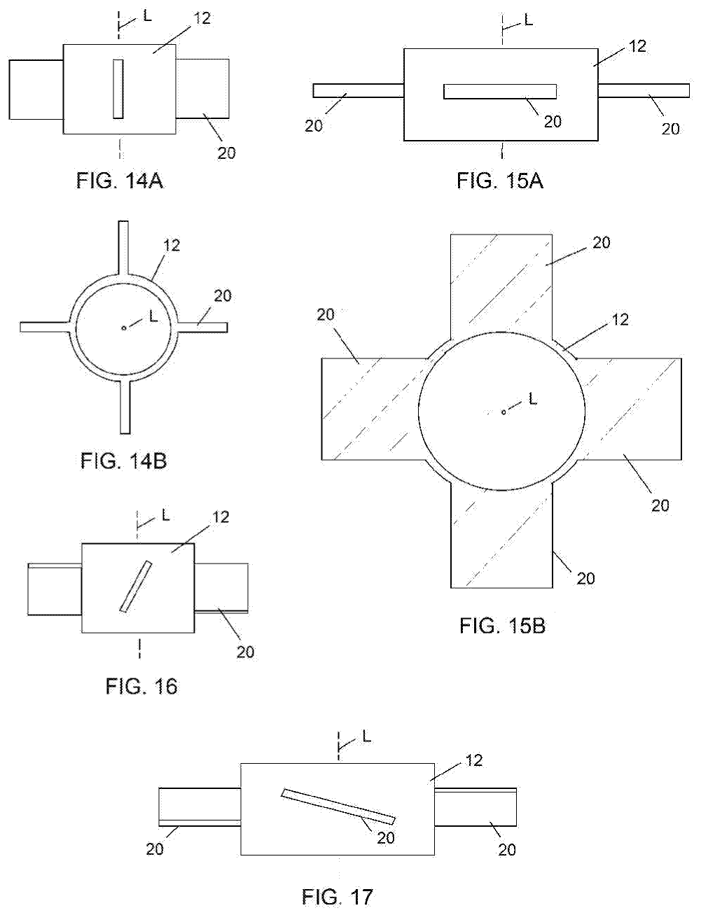

Illustrative embodiments are shown in FIGS. 14A-17. FIG. 14A is a side view of a portion of a finned tube having a tube 12 with radial fins 20. That is, only a portion of the length of the tube is shown, and the tube may be longer than as shown. FIG. 14B is a top plan view of the finned tube of FIG. 14A. As indicated, the finned tube includes four vertically-oriented fins spaced apart from one another by 90 degrees around the circumference of the tube. (That is, a plane of the largest surface of the fin is parallel to a longitudinal axis 1′ of the tube.) The fins may be longer than as illustrated (length defined along an axial direction/longitudinal axis of the tube), e.g., they may extend along a length, such as the entire length, of the tube. In another embodiment, with reference to FIG. 16, the fins 20 of a finned tube are canted or angled off the vertical (again, relative to the longitudinal axis 1′ of the tube) by, for example, an angle of from greater than zero degrees to 45 degrees, or less than 45 degrees. FIGS. 15A and 15B show another embodiment of a finned tube. FIG. 15A is side view of a portion of the finned tube. That is, only a portion of the length of the tube is shown, and the tube may be longer than as shown. FIG. 15B is a top plan view of the finned tube of FIG. 15A. The finned tube includes a tube 12 and four radial fins 20, which are spaced apart from one another around the circumference of the tube by 90 degrees. The fins are laterally or horizontally oriented, i.e., planes of the largest surfaces of the fins are normal to the longitudinal axis 1′ of the tube. In another embodiment, with reference to FIG. 17, the fins 20 of a finned tube are canted or angled off the horizontal (again, relative to a plane normal to the longitudinal axis 1′ of the tube) by, for example, an angle of from greater than zero degrees to 45 degrees, or less than 45 degrees. In all the illustrated embodiments, the tubes and fins may be integrally formed as a single piece using an additive manufacturing process. Additionally, there may be more or fewer fins, and/or the fins may have different shapes, and/or the fins may be positioned differently than as shown, including irregular or staggered configurations or combinations of horizontally-oriented, vertically-oriented, and/or canted or angled fins. The fins may also have features or configurations as shown elsewhere herein, e.g., corrugations.

Referring now to FIG. 1B, in an embodiment, the wall thickness of the tube 12 (and thus the cross-sectional flow area) may be increased at a location adjacent to the tube/header plate interface, similar to that shown in FIG. 1A, but rather than continue this increased wall thickness through the header plate 18, the wall thickness decreases progressively throughout the width of the header plate 18 at the very proximal end of the tube 12. This configuration provides for increased joint strength, as discussed above, while at the same time helps reduce flow losses by decelerating the flow wherever required across the header plate. As shown in FIG. 1B, in this configuration, the inside diameter of the tube 12 increases at least throughout the width of the header plate 18.

As illustrated in FIG. 1C, in some embodiments, the wall thickness of the tubes 12 adjacent to the header plate 18 may likewise be increased (as compared to the tube wall thickness at a point distal from the header plate 18) as discussed above. As shown in FIG. 1C, however, the tube wall may be manufactured such that the inside diameter of the tube decreases towards its proximal end where it is joined to the header plate 18. This decrease in inside diameter of the tube 12 provides a decreasing cross-sectional flow area that can be utilized to achieve flow acceleration and improved mixing with the bulk fluid beyond the header plate 18.

In embodiments, the inside diameter of a finned tube (that is, the diameter of the interior passageway of the tube) is constant along an entire length of the tube. In embodiments, the inside diameter of a fined tube is constant along a portion of the length of the tube, whereas along other portions of the tube, such as an end portion, the inside diameter gradually increases or decreases (e.g., increases or decreases to a maximum or minimum inside dimeter of the passageway, respectively, at the end of the tube). In embodiments, the outer diameter of the tube is constant along the entire length of the tube. In embodiments, the outer diameter of the tube increases or decreases along a portion of the length of the tube, e.g., part of the length of the tube may have a constant outer diameter and then the outer diameter, along a different part of the tube, increases or decreases. This may be in combination with any of a constant inner diameter or an inner diameter that additionally or alternatively increases or decreases, such that the wall thickness of the tube may be constant along the entire length of the tube, or the wall thickness may vary (become thicker or thinner relative to another portion of the wall thickness) along all or part of the tube's length.

Referring now to FIGS. 1D and 1E, in an embodiment, additive manufacturing can be utilized not only to vary the cross-sectional area of the tubes 12, and to vary the inside diameter of the tubes 12, as desired, but to produce fins having varying heights, widths, configurations, etc. For example, as shown in FIG. 1D, the additive manufacturing techniques discussed above can likewise be utilized to produce a tube 12 having integral fins 20, wherein the fins have different heights (e.g., measured as a dimension of the fin along a direction normal to the longitudinal or center axis of the tube). Moreover, as shown in FIG. 1E, additive manufacturing can be utilized to produce any fin configuration desired, such as tapered fins. In particular, as shown in FIG. 1E, in an embodiment, the fins can be manufactured with a thicker base (attached to the tube) that tapers to a narrower distal end.

While FIGS. 1A-1E illustrate cylindrically-shaped heat exchanger tubes 12 (having a generally circular cross-section), the invention is not so limited in this regard. In particular, it is contemplated that the tubes 12 may have any cross-sectional shape such as, for example, ovular, elliptical, airfoil, triangular (e.g., with filleted corners), square (e.g., with filleted corners), etc. The various tube configurations discussed herein and shown in FIGS. 1A-1E (i.e., constant cross-sectional area, varying cross-sectional area, constant inside diameter, varying inside diameter) may likewise be applied to any of the embodiments hereinafter described.

In an embodiment, the fins 20 may be additively manufactured with structures or other configurations that function to increase the structural strength or facilitate heat transfer. For example, as illustrated in FIG. 2, the tubes 12 and/or fins 20 may be formed with one or more of corrugations 30, grooves (elongate indentations, either rounded/trough-like, or angled) 32, dimples (rounded or circular indentations) 34, and/or projections 36 to enhance heat transfer. The corrugations 30 function to increase the surface area of the fins 20, thereby enhancing heat transfer to or from the working fluid in the heat exchanger. The fins 20 may likewise be manufactured to be any combination of flat, corrugated, and/or helical shape (e.g., a continuous fin that extends helically around the circumference and along at least part of the length of the tube).

In an embodiment, a corrugated fin, instead of being generally planar or flat, has an undulating shape. For example, a corrugated fin may include a first portion defining main planar sides, a second portion defining main planar sides that are orientated at a non-zero degree angle (e.g., forty-five degrees) to the planar sides of the first portion, a third portion defining main planar sides that are oriented at a non-zero degree angle (e.g., forty-five degrees) to the planar sides of the second portion, and so on. Alternatively or additionally, a corrugated fin may have portions that in cross section are sinusoidal in shape or otherwise curved or rounded.

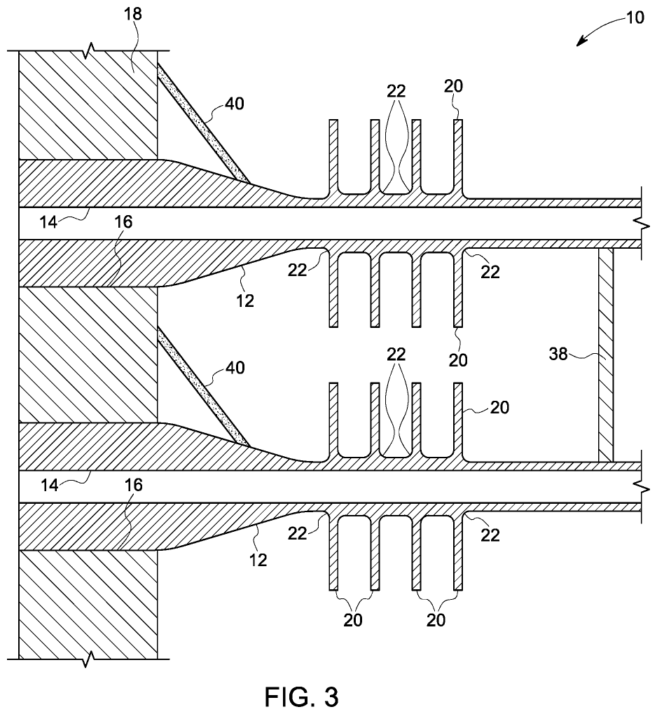

Referring now to FIG. 3, additive manufacturing/3D printing can be utilized to create structural elements such as ribs 38 and/or struts 40 during the manufacture of the tubes 12 and fins 20 to provide structural rigidity to the heat exchanger core (i.e., increased strength at desired/required locations) to provide the high temperature strength required. For example, a rib may be a member (e.g., an elongate, bar-like member) that extends between, and is integrally connected with, two or more adjacent finned tubes. As another example, a strut may be a member (e.g., an elongate, bar-like member) that extends between and is connected to a tube and a header, which is at least integrally connected with the tube. (Although the ribs and struts are shown in FIG. 3 as being comprised of different materials than the tubes and/or header, in embodiments the ribs (and/or struts) and tubes are made of a same, integrally-formed material using an additive manufacturing process. In another embodiment, the header is made of the same material and integrally formed with the tubes and/or ribs and/or struts.)

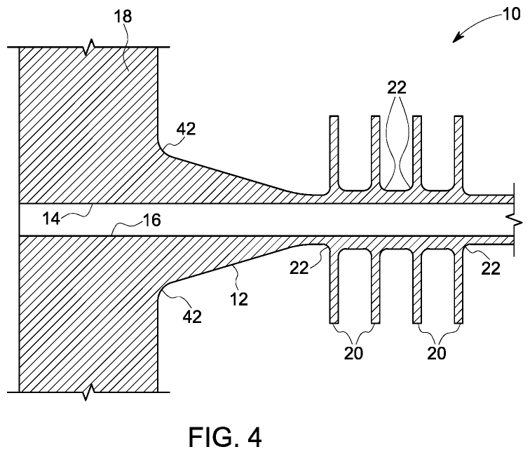

With reference to FIG. 4, in an embodiment, the header 18 and tubes 12 (and any integrated fins 20, fillets 22, ribs 38, struts 40, grooves 32, dimples 34, and/or projections 36) may likewise be additively manufactured as a single component. By additively manufacturing the tubes 12 and header 18 in a single operation, the need to separately manufacture the tubes and the header, and subsequently join them in a separate process step through an interference fit or welding, can be eliminated. As discussed above, this method allows for a full metal contact at the header-tube interface, thereby eliminating the possibility of thermal contact resistance at such junction. In addition, the use of additive manufacturing to produce the tubes and header allows for the creation of integrally-formed fillets 42 at the header-tube interface. The ability to provide these fillets 42 at this interface reduces the stresses seen in this region when exposed to high temperatures during operation, minimizing the likelihood that cracks will develop, which could lead to leaking or decreased heat transfer.

As illustrated in FIG. 4, embodiments of the invention provide for the manufacture of an entire heat exchanger assembly as a single, unitary component, allowing for the integration of the tubes with the header, and the tubes with the fins, as well as the creation of any struts, ribs, grooves, dimples, projections, corrugations, or the like which aid in structural support and or heat transfer without any mechanical joining means or welding. With further reference to FIGS. 1A-3, in some embodiments, rather than manufacturing the entire assembly as a single, integrated component, the tubes and fins and associated components that enhance heat transfer can be manufactured as an integrated component via additive manufacturing without any mechanical joining or welding, and this subassembly can then be joined to the header by various mechanical means or welding. In one embodiment, plural tubes are joined to one another by plural ribs 38 (see FIG. 3), with the entire subassembly (of plural tubes and ribs) being formed as a unitary/integral component using an additive manufacturing process; the subassembly can then be moved into place for attachment to a header in a single operation.

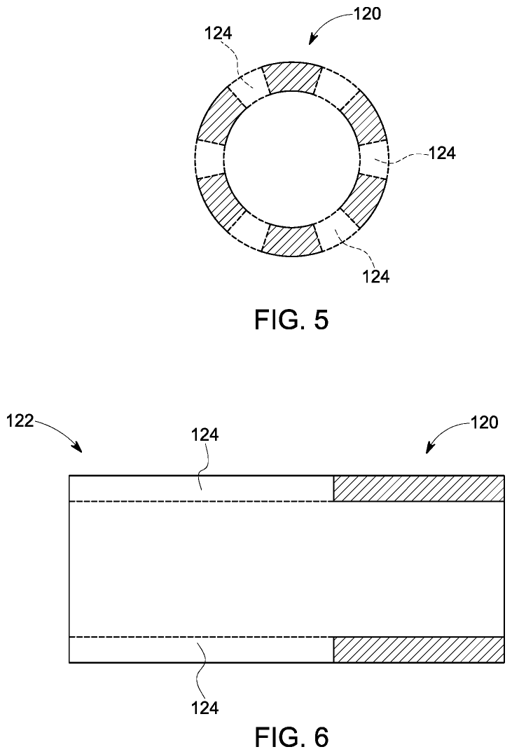

Turning now to FIGS. 5-10, in situations where the header and the tubes (and fins) are manufactured in separate processes and then subsequently joined, embodiments of the invention also contemplate the use of additive manufacturing to provide end preparations on the end portion of the respective tubes 12 that facilitate subsequent joining to the header 18. For example, as shown in FIGS. 5 and 6, a tubular member 120 (e.g., for a heat exchanger) having an end preparation 122 according to an embodiment of the invention is illustrated. As shown therein, the end preparation 122 is in the form of a plurality of circumferential slots 124 or grooves formed on the end portion of the tubular member 120. In an embodiment, the circumferential slots 124 have a length that generally corresponds to the width of the header wall to which the tubular member 120 is joined. These slots 122 are formed in the tube as part of the additive manufacturing process for the tube and fins (and other structures) discussed above. After the tubes 120 with slots 124 are formed through additive manufacturing, the end portion of the tube may be inserted into the opening 16 in the header 18 and welded or otherwise attached in place. The circumferential slots help improve weld penetration as compared to conventional methods, and therefore increase the life of the joint.

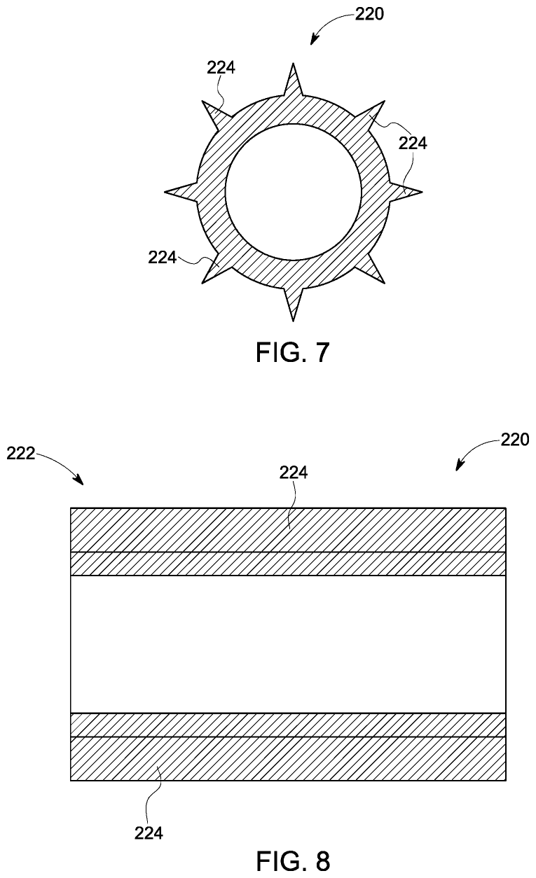

With reference to FIGS. 7 and 8, in an embodiment, a tubular member 120 (e.g., for a heat exchanger) having an end preparation 222 according to an embodiment of the invention is illustrated. As shown therein, the end preparation 222 is in the form of a plurality of radial projections 224 formed on the end portion of the tubular member 220. The radial projections 224 have a length that generally corresponds to the width of the header wall to which the tubular member 220 is joined. As illustrated in FIG. 7, the projections 224 are triangular shaped, although other shapes such as square, arcuate, and the like are also possible. These projections 224 are formed in the tubular member 220 as part of the additive manufacturing process for the tube and fins (and other structures) discussed above. The header 18 may be formed with opening 16 having a corresponding array of machined (or otherwise formed) grooves or slots (not shown) for receiving the projections 224. After the tubular members 220 with projection 224 are formed, the projections 224 may be aligned with the corresponding grooves in the opening 16 in the header 18, and the end portion of the tubular member 220 may be inserted into the opening 16. These projections 224 increase the contact area between the tubular member 220 and header 18, and the wedge action ensures metal contact even during differential expansion. (Note that the interior solid lines of FIG. 8 are provided to show the presence of both the tube and projections, and do not necessarily represent that the tube and projections are separate parts or are not integrally formed of the same material, for example.)

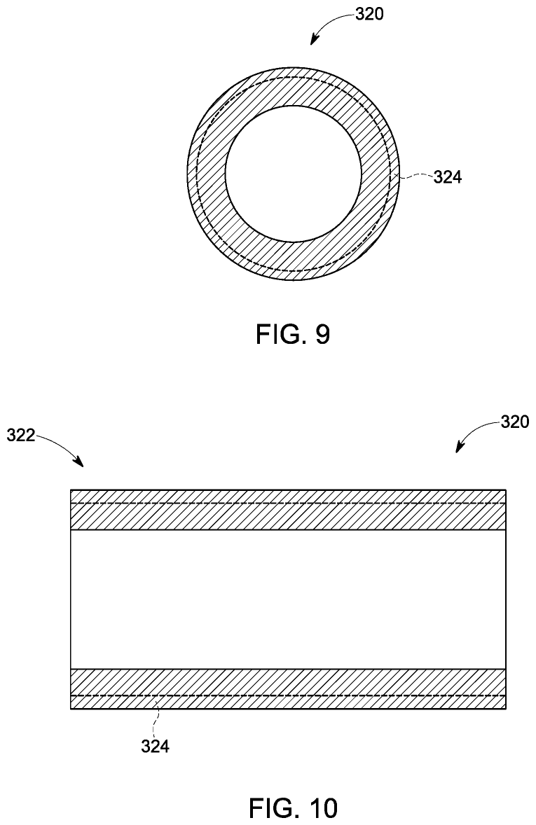

Turning to FIGS. 9 and 10, in another embodiment, a tubular member 320 (e.g., for a heat exchanger) having an end preparation 322 according to an embodiment of the invention is illustrated. As shown therein, the end preparation 322 is in the form of a plurality of threads 324 formed on the end portion of the tubular member 320. The threads extend for a distance that generally corresponds to the width of the header wall to which the tubular member 320 is joined. These threads 324 may be formed on the tubular member 320 as part of the additive manufacturing process for the tubular member and fins (and other structures) discussed above. In other embodiments, the threads may be machined into the end portion of the tubular member 320. The opening 16 in the header 18 likewise contains a corresponding set of threads (not shown) that can be formed via mechanical means such as cutting, or otherwise. During assembly, a high temperature sealant may be applied to the threads 324 and the tubular members 320 are then threadedly connected to the header 18. The sealant is given time to cure and functions to both secure the parts to one another and prevent leakage.

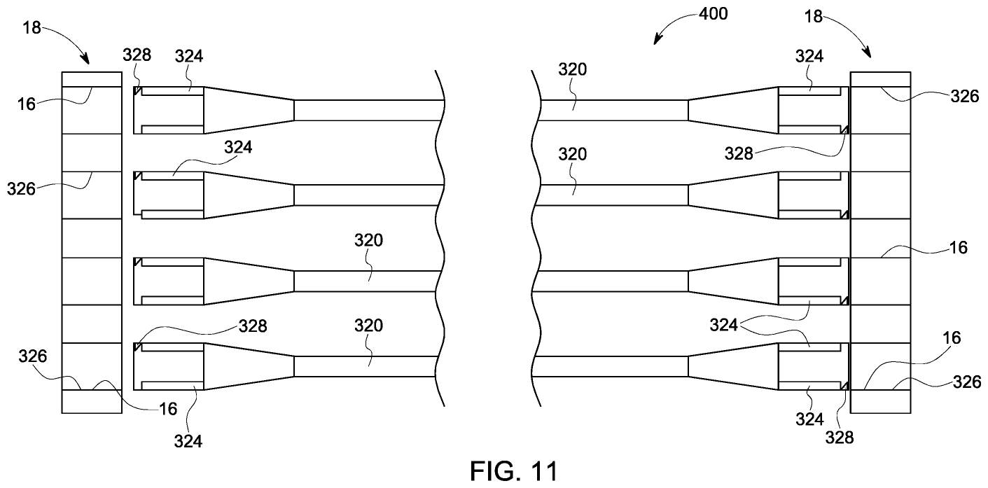

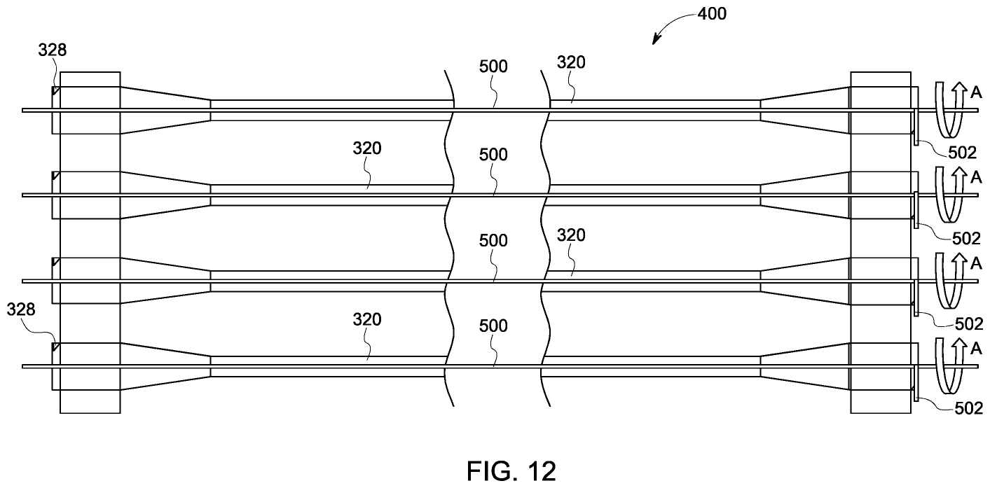

With reference to FIGS. 11 and 12, a heat exchanger apparatus 400 employing tubes 320 with end preparations 322 in the form of threads 324 is illustrated. As shown therein, the tubes 320 have threads 324 on opposed ends thereof that are configured to be threadedly received by corresponding threaded portions 326 in the openings 16 of opposing header plates 18. In an embodiment, the threads on one end of the tube are right hand threads or left hand threads, while the threads on the other end of the tube are the other of right hand threads or left hand threads (and the threads within the openings in the opposed header plates are similarly configured). At least one end of each tube 320 is formed with a notch 328. To assemble the heat exchanger apparatus 400, the tubes 320 are positioned intermediate opposed header plates 18, and a tool spindle 500 is inserted longitudinally through the tube 320, as shown in FIG. 12. A protrusion or key 502 on the tool spindle 500 is engaged with the notch 328 in the tube 320, and the spindle 500 is rotated in the direction of arrow A to effect rotation of the tube 320. As the tubes 320 are rotated, the threads 324 on the opposing ends of the tubes threadedly engage the openings 16 in the opposed header plates 18, drawing the header plates 18 towards one another (owing to the oppositely-threaded ends). After assembly, the tool spindle 500 can be removed.

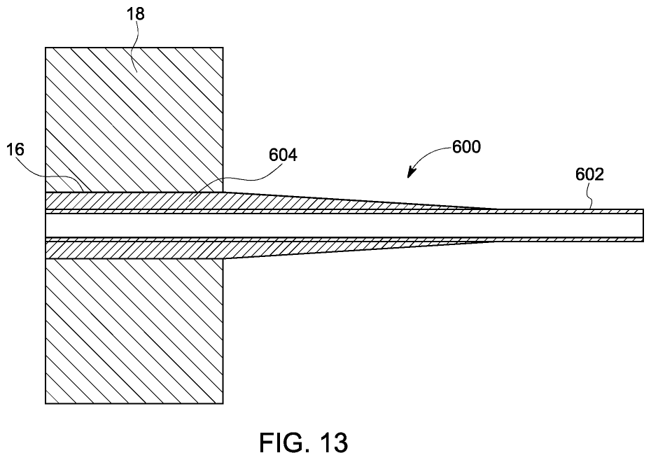

Referring to FIG. 13, in an embodiment, a tube (e.g., for a heat exchanger) may be manufactured with one of the joining features of FIGS. 5-10 using a hybrid process. In particular, in an embodiment, a heat exchanger tube 600 may include a tube core 602 manufactured by means such as extrusion, casting, or the like. Additive manufacturing technologies may then be utilized to overlay an end preparation 604 on an end portion of the tube 600. The end preparation 604 may be any one of the end preparations discussed above in connection with FIGS. 5-10, and may include slots, projections or threads. In this respect, the tube 600 includes a core manufactured via a first means, and a joining mechanism constructed on the tub via 3D printing (i.e., different than the first means). Depending on the particular joining mechanism, the opening 16 in the header 18 will be formed with a corresponding configuration to facilitate joining of the tube to the header. By adding a 3D printed end preparation to the exterior of a heat exchanger tube that is manufactured using means other than 3D printing, the higher cost of 3D printing the entire heat exchanger can be avoided.

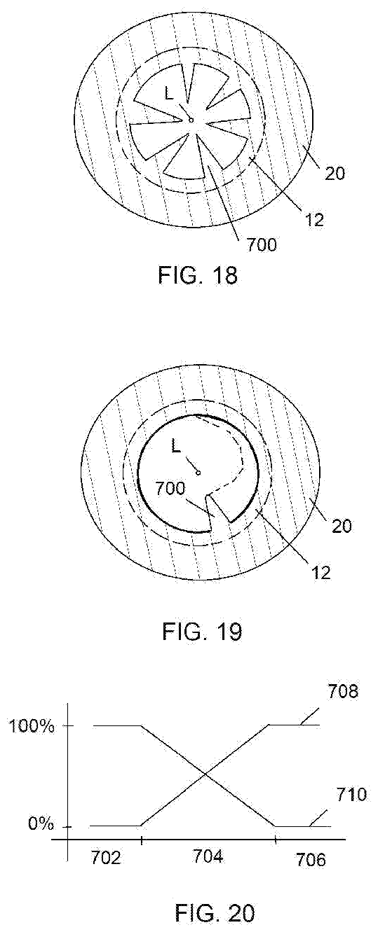

Tubes and tubular members (e.g., for a heat exchanger) may be provided with heat-removal constructs/features within the interior passageway, instead of interior passageways with plain or smooth walls. One example is shown in FIG. 18. Specifically, FIG. 18 shows an embodiment of a finned tube having a tube 12, integral radial fins 20 (one fin is shown, having an annular configuration), and an interior passageway extending along a longitudinal axis “L” of the tube. Plural interior heat transfer members 700 are integral with the tube wall and extend from the interior side of the tube wall inwards into the interior passageway. The heat transfer members may be ridges or triangular fins, as illustrated in the embodiment of FIG. 18, or they may have other shapes, such as convex dimples, rounded ridges, or the like. The heat transfer members may be elongate and extend along the interior passageway. Alternatively or additionally, the heat transfer members may be discrete protuberances, or they may extend along the passageway helically or spirally or otherwise. The interior heat transfer members may increase a surface area of contact between the tube and a fluid passing through the interior passageway (cooling or heating fluid, e.g., air, or water or another liquid), relative to an interior passageway with smooth or plain walls (or otherwise without the heat transfer members), thereby increasing the rate by which heat is transferred between the tube and fluid. Rounded interior heat transfer members, such as discrete convex dimples or rounded ridges, may perform the function of increasing the heat transfer rate while minimizing the likelihood of increased fouling of the interior of the passageway. The tube, fins, and interior heat transfer members may be an integral part, comprised of the same material, formed using an additive manufacturing process as described herein.

In an embodiment, a finned tube includes one or plural (e.g., two to four) heat transfer members, each of which is an elongate, triangular or rounded ridge (i.e., fin) that extends along the interior passageway, helically or spirally. That is, along a length of the interior passageway, the ridge curves around the interior passageway, such that the ridge in effect ‘wraps around’ the long axis of the tube instead of being parallel thereto. In one embodiment, with reference to FIG. 19, there is one and one only such ridge 700, which thereby increases the rate of heat transfer (between a fluid in the interior passageway and the tube wall) while minimizing flow impediment and/or the chances of increased fouling. The interior heat transfer members may be integrally formed with the tube and fins, using an additive manufacturing process. (An additive manufacturing process enables the creation of single-part finned tubes having complex shapes along the interior passageway.)

In embodiments, finned tubes and/or headers, as described herein, are assembled into a heat exchanger apparatus. For example, two or more headers with finned tubes extending therebetween may be disposed in an outer housing, with ducts attached to or part of the outer housing to route two fluids through the heat exchanger. (Alternatively, the headers may form walls of the outer housing.) Specifically, one fluid is routed through the finned tubes, and another fluid is routed around the exterior of the finned tubes but within the outer housing, for transfer of thermal energy between the two fluids, e.g., heat is transferred from a first fluid in the finned tubes, through the tube wall and fins, to a second fluid passing exteriorly around the finned tubes, or vice versa. The two fluids may be part of separate fluid circuits, such that the two fluids do not intermingle. The heat exchanger apparatus may be used for oil or other liquid cooling, for EGR or charge air cooling (i.e., for cooling air compressed by a compressor of a turbocharger, for combustion by an engine), or the like. The heat exchanger apparatus may be installed in a locomotive, other rail vehicle, marine vessel, or other vehicle, or it may be used in other heat exchange applications (e.g., for cooling or heating fluids associated with stationary machinery, such as a generator or other power generation equipment).

Embodiments of the invention therefore contemplate the use of additive manufacturing to produce a heat exchanger and/or headers, tubes, and/or fins thereof (e.g., finned tubes) that enhance heat transfer of the heat exchanger, minimize thermal contact resistance, and reduce the likelihood of stress cracks forming at tube/header and/or fin/tube interfaces. Embodiments of the invention may be applied to any heat exchanger that employs a fin-tube design such as, for example, intercoolers, EGR coolers, liquid cooled electronic heat sinks, heat pipes, or the like. In contrast to the invention, the current state of the art is limited by manufacturing technologies. In particular, the production of thin walled tubes necessary for proper heat transfer by conventional means precludes the ability to also form the joining structures contemplated by embodiments of the invention.

Accordingly, as discussed above, embodiments of the invention contemplate the use of additive manufacturing to produce heat exchanger tubes with integral fins, projections, dimples, and the like with almost any configuration desired. Moreover, the use of additive manufacturing allows for the cross-sectional area of the tubes and/or the inside diameter of the tubes to be varied as desired at various points along the length of the tubes to provide for, for example, increased joint strength (at the tube/header interface), reduced flow losses, and/or flow acceleration or deceleration, and/or to improve or alter the thermal performance (relative to tubes lacking such features or having different configurations).

In an embodiment, a heat exchanger apparatus includes a header having at least one opening, at least one tubular member joined to the header and having an interior passageway in fluid communication with the at least one opening, and a plurality of radial fins extending from the at least one tubular member. The tubular member and the plurality of radial fins are formed as a unitary component via additive manufacturing, e.g., without welding or interference fit. In an embodiment, the heat exchanger apparatus further includes a fillet formed at an interface between each radial fin and the tubular member. In an embodiment, the heat exchanger apparatus further includes a plurality of corrugations formed in the plurality of radial fins, wherein the plurality of corrugations are formed via additive manufacturing. In an embodiment, the header has a wall thickness greater than about 2 millimeters (e.g., 2 mm or greater) and the at least one tubular member has a wall thickness less than about 1 millimeter (e.g., 1 mm or less). In an embodiment, the heat exchanger apparatus further includes at least one of a groove, a dimple, and/or a projection formed in the tubular member, wherein the at least one of the groove, the dimple, and/or the projection is formed via additive manufacturing. In an embodiment, the at least one tubular member includes an end portion received in the at least one opening in the header, and the end portion includes an end preparation configured to facilitate joining of the at least one tubular member to the header. In an embodiment, the end preparation is one of a series of slots, a plurality of radial projections or a plurality of threads. In an embodiment, the end preparation is formed via additive manufacturing. In an embodiment, the header and the tubular member are formed as a unitary component via additive manufacturing, e.g., without welding or interference fit. In an embodiment, the at least one tubular member includes a core section formed via extrusion and an outer layer formed via additive manufacturing, where the outer layer and the plurality of fins form a unitary component devoid of any weld or interference fit. In an embodiment, the outer layer includes an end portion dimensioned to be received in the at least one opening in the header, and the end portion of the outer layer includes one of a series of slots, a plurality of radial projections or a plurality of threads configured to facilitate joining of the at least one tubular member to the header. In an embodiment, the heat exchanger apparatus may also include a second header have at least one second opening, the second header being positioned parallel and spaced from the header, where the at least one tubular member includes a first end having a first threaded portion formed via additive manufacturing and a second end having a second threaded portion formed via additive manufacturing, where the first threaded portion is one of a right hand threaded portion or a left hand threaded portion, where the second threaded portion is the other of a right hand threaded portion and a left hand threaded portion, and where the first threaded portion is threadedly received in the opening in the header and the second threaded portion is threadedly received in the second opening in the second header.

In an embodiment, a heat exchanger apparatus includes a header (or plural headers), plural tubular members, and a respective plurality of radial fins extending from each of the tubular members. The header includes plural openings. The plural tubular members are joined to the header (e.g., at the openings), and include respective interior passageways in fluid communication with the openings. The radial fins may be configured according to any of the embodiments described herein, alone or in combination. In one aspect, the tubular members and radial fins are formed as one or more unitary components, such that the tubular members and radial fins are monolithic components (e.g., comprised of the same piece of material). For example, the tubular members and fins may be manufactured using an additive manufacturing process. In another aspect, the tubular members and fins may be manufactured using an additive manufacturing process, but comprise different materials or gradients of materials, e.g., the additive manufacturing process may allow for ‘printing’ of multiple metals/alloys (or other materials), such that the fins are made of a first metal/alloy and the tube is made of the second metal/alloy, but the metals/alloys are integrally formed without a seam from welding or mechanical joining. In one aspect, a transition region between the fins and tubular member may comprise an alloy (or varying or gradient alloy) of the two metals, such that there is a gradient of metallic transition between the fins and tube, e.g., a first metal (or alloy), transitioning to an alloy or gradient of the first metal/alloy and a second metal/alloy, transitioning to the second metal/alloy. FIG. 20 shows one embodiment of a material gradient between a fin and a tube, for example. The y-axis of FIG. 20 is percentage of material (from 0% to 100%) of first and second, different materials 708, 710, and the x-axis is distance (along an axis extending from the tube through to the fin), divided into three regions, namely, the tube 702, a transition region 704, and the fin 706. As indicated, in the tube region 702 the composition is 100% the second material 710, and in the fin region 706 the composition is 100% the first material 708. In the transition region 704 between the tube region and the fin region, in the direction extending from the tube to the fin, the second material 710 gradually transitions (e.g., linear transition, or a non-linear transition)) from 100% to 0%, and the first material 708 gradually transitions (e.g., the same or a different linear transition, or the same or a different non-linear transition) from 0% to 100%. (The transitions are complementary, such that a combination of the two materials is 100% of the total composition). Alternatively, there may be three or more materials, depending on the additive manufacturing process used.

In an embodiment, a heat exchanger apparatus includes a header (or plural headers), plural tubular members, and a respective plurality of radial fins extending from each of the tubular members. The header includes plural openings. The plural tubular members are joined to the header (e.g., at the openings), and include respective interior passageways in fluid communication with the openings. In one aspect, the tubular members and radial fins are formed as one or more unitary components, such that the tubular members and radial fins are monolithic components (e.g., comprised of the same piece of material). For example, the tubular members and fins may be manufactured using an additive manufacturing process. In another aspect, the tubular members and fins may be manufactured using an additive manufacturing process, but comprise different materials or gradients of materials. The heat exchanger may further include one or more of, and/or have one or more of the following configurations: fillets formed at interfaces between the radial fins and the tubular members; a respective plurality of corrugations formed in each of the plurality of radial fins (e.g., the plurality of corrugations may be formed via additive manufacturing); the header has a wall thickness of at least 2 mm and the tubular members (not including the fins) have wall thicknesses of no more than 1 mm; at least one of grooves, dimples, and/or projections formed (e.g., via additive manufacturing) in the tubular members; the tubular members include respective end portions received in the openings of the header, where the end portions include respective end preparations configured to facilitate joining the tubular members to the header (e.g., the end preparations may be one or more of series of slots, pluralities of radial projections, or pluralities of threads, and/or the end preparations may be formed via additive manufacturing); the header and the tubular members are formed as a unitary component via additive manufacturing without welding or interference fit; the tubular members include respective core sections (e.g., formed via extrusion) and separate outer layers formed via additive manufacturing, where the outer layers and the plurality of fins form respective unitary components, e.g., devoid of any weld or interference fit; the tubular members have respective cross-sectional areas that vary along lengths of the tubular members; the tubular members have respective cross-sectional areas adjacent to the header that are greater than cross-sectional areas at point(s) distal from the header; and/or the interior passageways of the tubular members have respective inside diameters that vary along lengths of the tubular members.

In an embodiment, a heat exchanger apparatus (e.g., for a locomotive or other vehicle) includes a header (e.g., a header plate), plural tubular members, plural radial fins, and plural fillets. The header has plural openings. The plural tubular members are joined to the header and have respective interior passageways in fluid communication with the openings (e.g., the tubular members may be disposed in the openings, with the interior passageways being in fluid communication with a space, for example as defined by a plenum or housing, adjacent the openings). A respective plurality of plural radial fins extends from each of the tubular members; one or more of the radial fins include a respective plurality of corrugations formed therein. The plural fillets are formed at interfaces between the radial fins and the tubular members. The header has a wall thickness of at least 2 millimeters and the tubular members have respective wall thicknesses of no more than 1 millimeter. The tubular members, the radial fins, and the fillets are monolithic components, meaning a unitary component made of the same piece of material, or a unitary component made from plural materials but without seams from welding or other joining of separate parts. For example, the tubular members, fins, and the fillets may be formed using additive manufacturing, without welding or interference fits.

In an embodiment, a heat exchanger apparatus (e.g., for a locomotive or other vehicle) includes a header having plural openings, and plural finned tubes joined to the header and having respective interior passageways in fluid communication with the openings. For example, ends of the finned tubes may be disposed in the openings, with the interior passageways being in fluid communication with a space, for example as defined by a plenum or housing, adjacent the openings on the side of the header opposite the tubes. Each of the finned tubes respectively includes a tubular member defining a respective one of the interior passageways and having a wall thickness of no more than 1 millimeter, a plurality of radial fins extending from the tubular member, where one or more of the radial fins include a respective plurality of corrugations formed therein and one or more fillets formed at interfaces between the radial fins and the tubular member. The header has a wall thickness of at least 2 millimeters. Also, the finned tubes are monolithic, such that for each finned tube, the tubular member, fins (with corrugations), and fillet(s) are a unitary component, made of the same piece of material or from plural materials without seams from welding or other joining of separate parts. For example, each finned tube may be integrally formed of the same material, using an additive manufacturing process, or integrally formed of different materials using an additive manufacturing process.

In another embodiment, a method of manufacturing a heat exchanger includes the step of forming a tubular member having an end preparation configured to facilitate joining of the at least one tubular member to a header plate having an opening. The end preparation comprises, e.g., one of a series of slots, a plurality of radial projections, or a plurality of threads, and is formed via additive manufacturing. The method also includes joining the tubular member to the header plate. In an embodiment, the step of forming the tubular member includes forming a core section of the tube via extrusion and forming an outer layer over the core section via additive manufacturing, where the outer layer includes the end preparation. In an embodiment, the method may also include the step of forming at least one of a groove, a dimple, and/or a projection in the tubular member via additive manufacturing. In an embodiment, the method may also include the step of forming a plurality of radial fins extending from the tubular member via additive manufacturing such that the tubular member and the plurality of radial fins form a unitary component. In an embodiment, the method may also include a step of, via additive manufacturing, forming a fillet formed at an interface between each radial fin and the tubular member.

In another embodiment, a method of manufacturing a heat exchanger apparatus includes the step of, via additive manufacturing, integrally forming a tubular member with at least one of a header plate and/or at least one radial fin. In an embodiment, the header has a wall thickness greater than about 2 millimeters (e.g., 2 mm or greater), the tubular member has a wall thickness less than about 1 millimeter (e.g., 1 mm or less), and the method further includes the step of, via additive manufacturing, forming at least one of a groove, a dimple, a projection, or a fillet in the tubular member. In an embodiment, the method further includes the step of, via additive manufacturing, forming one of a series of slots, a plurality of radial projections, or a plurality of threads in an end portion of the tubular member.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. A locomotive heat exchanger apparatus, comprising:
a header having at least one opening;
at least one tubular member joined to the header and having an interior passageway in fluid communication with the at least one opening; and
a plurality of radial fins extending from the at least one tubular member;
wherein the tubular member and the plurality of radial fins are formed as a unitary component via additive manufacturing without welding or interference fit.

2. The heat exchanger apparatus of claim 1, further comprising:
a fillet formed at an interface between each radial fin and the tubular member.

3. The heat exchanger apparatus of claim 1, further comprising:
a plurality of corrugations formed in the plurality of radial fins;
wherein the plurality of corrugations are formed via additive manufacturing.

4. The heat exchanger apparatus, of claim 1, wherein:
the header has a wall thickness of at least 2 millimeters; and
the at least one tubular member has a wall thickness of no more than 1 millimeter.

5. The heat exchanger apparatus of claim 4, further comprising:
at least one of a groove, a dimple and/or a projection formed in the tubular member;
wherein the at least one of the groove, the dimple and/or the projection is formed via additive manufacturing.

6. The heat exchanger apparatus of claim 4, wherein:
the at least one tubular member includes an end portion received in the at least one opening in the header; and
wherein the end portion includes an end preparation configured to facilitate joining of the at least one tubular member to the header.

7. The heat exchanger apparatus of claim 6, wherein:
the end preparation is one of a series of slots, a plurality of radial projections, or a plurality of threads.

8. The heat exchanger apparatus of claim 7, wherein:
the end preparation is formed via additive manufacturing.

9. The heat exchanger apparatus of claim 1, wherein:
the header and the tubular member are formed as a unitary component via additive manufacturing without welding or interference fit.

10. The heat exchanger apparatus of claim 1, wherein:
the at least one tubular member includes a core section formed via extrusion and an outer layer formed via additive manufacturing;
wherein the outer layer and the plurality of fins form a unitary component devoid of any weld or interference fit.

11. The heat exchanger apparatus of claim 10, wherein:
the outer layer includes an end portion dimensioned to be received in the at least one opening in the header; and
wherein the end portion of the outer layer includes one of a series of slots, a plurality of radial projections, or a plurality of threads configured to facilitate joining of the at least one tubular member to the header.

12. The heat exchanger apparatus of claim 1, further comprising:
a second header having at least one second opening, the second header being positioned parallel and spaced from the header;
wherein the at least one tubular member includes a first end having a first threaded portion formed via additive manufacturing and a second end having a second threaded portion formed via additive manufacturing;
wherein the first threaded portion is one of a right hand threaded portion or a left hand threaded portion;
wherein the second threaded portion is the other of the right hand threaded portion or the left hand threaded portion; and
wherein the first threaded portion is threadedly received in the opening in the header and the second threaded portion is threadedly received in the second opening in the second header.

13. The heat exchanger apparatus of claim 1, wherein:
the at least one tubular member has a cross-sectional area that varies along a length of the at least one tubular member.

14. The heat exchanger apparatus of claim 13, wherein:
the at least one tubular member has a cross-sectional area adjacent to the header that is greater than a cross-sectional area at a point distal from the header.

15. The heat exchanger apparatus of claim 1, wherein:
the interior passageway of the at least one tubular member has an inside diameter that varies along a length of the at least one tubular member.

16. A locomotive heat exchanger apparatus, comprising:
a header having plural openings and a wall thickness of at least 2 millimeters; and
plural finned tubes joined to the header and having respective interior passageways in fluid communication with the openings;
wherein each finned tube of the plural finned tubes respectively comprises:
a tubular member defining a respective one of the interior passageways and having a wall thickness of no more than 1 millimeter;
a plurality of radial fins extending from the tubular member, wherein one or more of the radial fins include a respective plurality of corrugations formed therein; and
one or more fillets formed at interfaces between the radial fins and the tubular member;
wherein the finned tubes are formed as monolithic components.

17. The heat exchanger apparatus of claim 16, wherein the finned tubes are formed using additive manufacturing, without welding or interference fits between the tubular members, the fins, and the fillets.

18. A locomotive heat exchanger apparatus, comprising:
a header having plural openings;
plural tubular members joined to the header and having respective interior passageways in fluid communication with the openings; and
a respective plurality of radial fins extending from each of the tubular members;
wherein the tubular members and the radial fins are formed as respective monolithic components.

19. The heat exchanger apparatus of claim 18, further comprising:
plural fillets formed at respective interfaces between the radial fin and the tubular members; and
a plurality of corrugations formed in the each of the plurality of radial fins, wherein the plurality of corrugations are formed via additive manufacturing;
wherein the header has a wall thickness of at least 2 millimeters and the tubular members have respective wall thicknesses of no more than 1 millimeter.

20. The heat exchanger apparatus of claim 18, wherein the tubular members and the radial fins are formed via additive manufacturing without welding or interference fit.

21-28. (canceled)
